(19) United States
(12) Patent Application Publication
(10) Pub. No.: US 2014/0050843 A1
(43) Pub. Date: Feb. 20, 2014

(54) DUAL SINGLE SIDED SPUTTER CHAMBERS WITH SUSTAINING HEATER

(71) Applicants: Chang B. YI, FREMONT, CA (US); Hongling LIU, Sunnyvale, CA (US); Hua YUAN, Fremont, CA (US); Tatsuru TANAKA, Campbell, CA (US)

(72) Inventors: Chang B. YI, FREMONT, CA (US); Hongling LIU, Sunnyvale, CA (US); Hua YUAN, Fremont, CA (US); Tatsuru TANAKA, Campbell, CA (US)

(73) Assignee: WD MEDIA, INC., San Jose, CA (US)

(21) Appl. No.: 13/588,946

(22) Filed: Aug. 17, 2012

(51) Int. Cl. G11B 5/851

(52) U.S. Cl. 427/132; 118/58; 427/127

(57) ABSTRACT

A disk processing system having a heater chamber and dual single-sided sputter chambers each with a sustaining heater.

### TECHNICAL FIELD

Embodiments described herein relate to the field of disk processing systems, and, in particularly, to a disk processing system a heater chamber and dual single-sided sputter chambers each with a sustaining heater.

### BACKGROUND

In order to achieve increased areal density of hard disk drive media, EMAR energy-assisted magnetic recording (EAMR) is the next generation of media being developed after the current perpendicular magnetic recording (PMR) media. In EAMR, the recording medium is locally heated to decrease the coercivity of the magnetic material during write operations. The local area is then rapidly cooled to retain the written information. This allows for magnetic write heads to be used with high coercivity magnetic materials. The heating of a local area may be accomplished by, for example, a heat or thermal source such as a laser.

In order to produce good quality EMAR media, a high temperature process is required. In conventional EMAR, and PMR, processes, media is separately heated and sputtered in different chambers. More specifically, a media disk is heated to a certain temperature in first chamber, before it goes to a different, sputter chamber to be deposited with the required film. However, the disk starts to cool down after it leaves the heating chamber and continues cooling down while the film is deposited in the sputter chamber.

Various processing systems are used in the fabrication of magnetic recording disks. One such processing system is the Anelva disk sputtering system. The Anelva sputter system is a double sided processing system in which both sides of a disk are processed simultaneously in each chamber. FIG. 1 is a cross-sectional top view of such a conventional double sided disk processing system 110 in which two disks 101 loaded within a carrier are transported to a heater chamber 110 that heats both sides of the disk 101 using heaters 112 and 114 on opposite sides of the disks 101. The disks 301 are subsequently transported to a double sided sputter deposition chamber 120 that deposits sputter material on both sides of the disks 101 using sputter assemblies 122 and 124 on opposite sides of the disks 101.

As shown in FIG. 2, the temperature of the disks 101 rises in the heater chamber 110 (a first portion due to the first heater element on each side and a second portion due to the second heater element on each side) and then starts to cool down as soon as the disks leave the heater chamber 110. Although the sputter deposition chamber 120 provides some heating during sputtering, the temperatures of the disk continue to drop during the deposition process. Such a temperature drop may result in different sputter film properties that negatively impact media performance.

### BRIEF DESCRIPTION OF THE DRAWINGS

The present invention is illustrated by way of example, and not limitation, in the figures of the accompanying drawings in which:

FIG. 1 is a cross-sectional top view of a conventional disk sputtering system.

FIG. 2 is a graph of disk temperature during processing using the conventional disk processing system of FIG. 1.

FIG. 3 is a cross-sectional top view of a disk processing system having two, single-sided deposition chambers, each with a sustaining heater, according to one embodiment of the present invention.

FIG. 4 is a cross-sectional top view of a single-sided deposition chamber according to one embodiment.

FIG. 5 is a cross-sectional top view of a single-sided deposition chamber according to another embodiment.

FIG. 6 is a cross-sectional side view of a single-sided deposition chamber according to one embodiment.

FIG. 7 is a graph of disk temperature versus sustaining heater power.

FIG. 8 is a flowchart of a method of processing a disk.

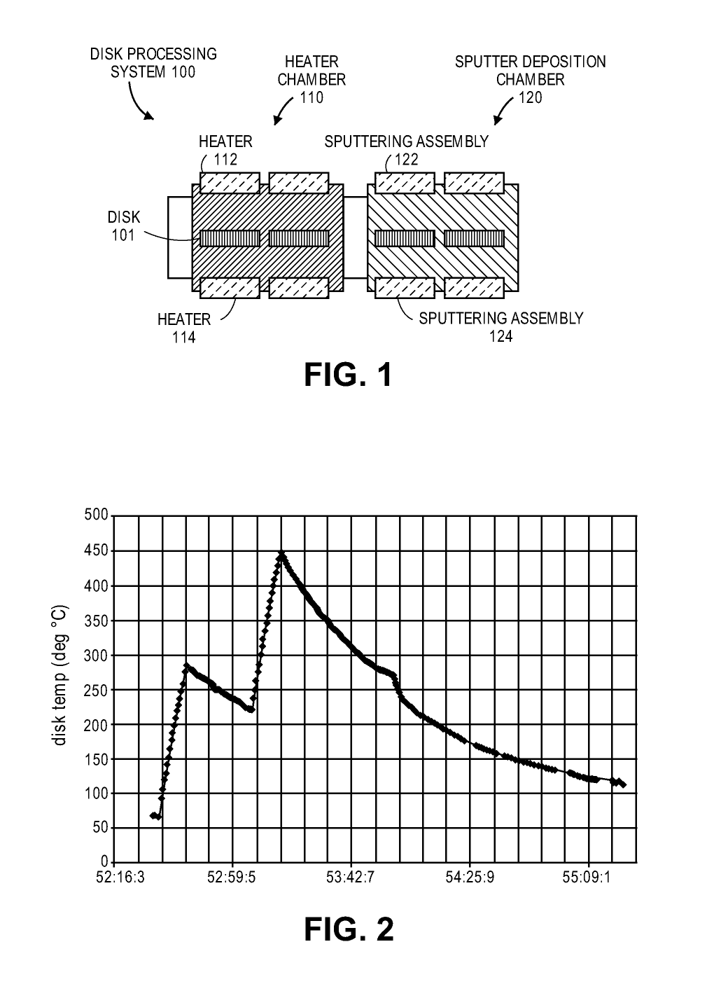

### DETAILED DESCRIPTION

Embodiments of a method are described herein with reference to figures. However, particular embodiments may be practiced without one or more of these specific details, or in combination with other known methods, materials, and apparatuses. In the following description, numerous specific details are set forth, such as specific materials, dimensions and processes parameters etc. to provide a thorough understanding. In other instances, well-known manufacturing processes and equipment have not been described in particular detail to avoid unnecessarily obscuring the claimed subject matter. Reference throughout this specification to “one embodiment” means that a particular feature, structure, material, or characteristic described in connection with the embodiment is included in at least one embodiment of the invention. Thus, the appearances of the phrase “in one embodiment” in various places throughout this specification are not necessarily referring to the same embodiment. Furthermore, the particular features, structures, materials, or characteristics may be combined in any suitable manner in one or more embodiments.

Embodiments of a disk processing system having a heater chamber and dual single-sided sputter chambers each with a sustaining heater are described. In one embodiment, the disk processing system includes three chambers. The first chamber includes two heaters disposed on opposite sides of the chamber which act to heat the disk to a certain temperature. The second chamber includes a sputter assembly opposite a heater. The sputter assembly deposits a film on one side of the disk while the heater maintains the temperature of the disk. The third chamber also includes a sputter assembly opposite a heater, but reversed such that sputter assembly deposits a firm on the other side of the disk while the heater maintains the temperature of the disk.

The heaters in each of the sputtering chambers maintain the disk temperature during transport of the disks into the chamber and the sputtering process. As such, the heaters may be referred to as sustaining heaters. In contrast, the heaters within the first chamber are used to get the disks to or near (either above or below) the temperature required for the sputtering operations prior to transport into the sputtering chambers and, as such, may be referred to as “pre-heaters” in that they perform heating of the disk prior to the heating in the chambers in which sputtering is performed at a required temperature. Maintaining approximately a constant temperature during transport and sputtering of a film, for example, to be used as the recording layer of EAMR media may help to produce a high quality of the EAMR deposited film and, thereby, improve the signal to noise ratio (SNR) of the film over 1 db, among other recording performance improvements that may be achieved.

In one embodiment, a shield is mounted on a shield holder and installed in front of the heating element within the sputtering chambers. This shield can prevent a film of the sputtering material from depositing on the heating element. In addition, the shield may also provide uniform heating to the disk, because it is thermally isolated to keep a high temperature and, thus, high heating rate.

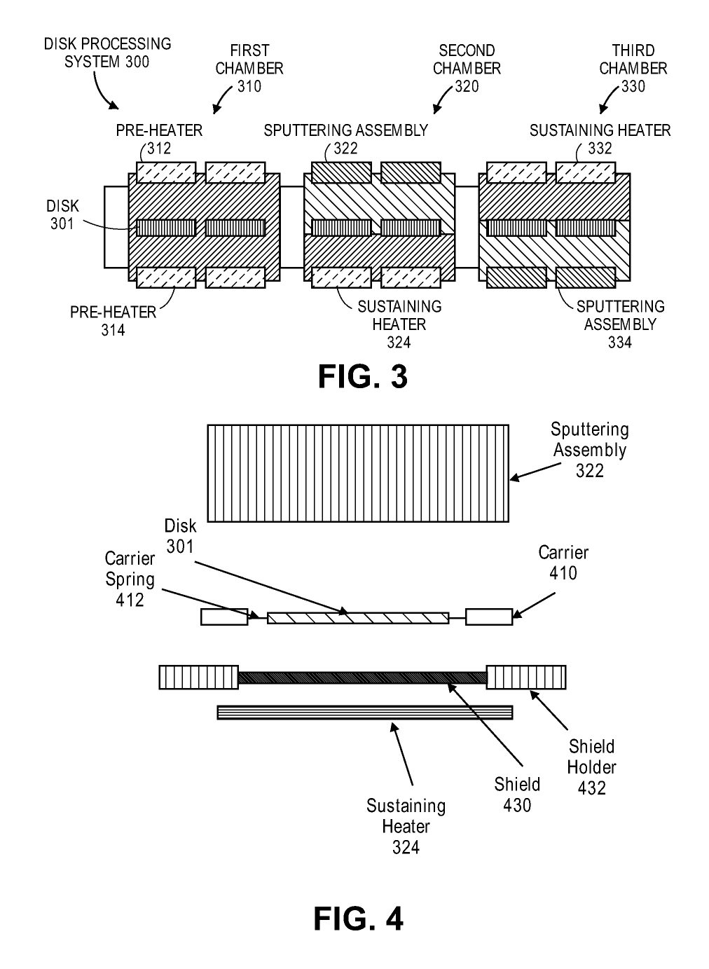

FIG. 3 illustrates a cross-sectional top view of a disk processing system having two, single-sided deposition chambers, each with a sustaining heater, according to one embodiment of the present invention. The disk processing system 300 includes a first chamber 310, a second chamber 320, and a third chamber 330. Disks 301 are carried and transported through the three chambers 310, 320, and 330. Disk carriers and transport systems, for example, manufactured by Intevac and Anelva are known in the art; accordingly, further details are not provided herein.

While in the first chamber 310, both sides of the disks 301 are exposed to pre-heaters. A first side is exposed to a first pre-heater 312 and the opposite, second side is exposed to second pre-heater 314. Once the disks 301 reach a certain temperature, the disks 301 are transported to the second chamber 320.

While in the second chamber 320, the first side of the disks 301 is exposed to a sputtering assembly 322 and the second side is exposed to a sustaining heater 324. The sputtering assembly 322 deposits a film on the first side of the disks 301 and the sustaining heater 324 sustains the temperature reached in the first chamber 310. Once the first side of the disks 301 has been sputtered, the disks 301 are transported to the third chamber 330.

While in the third chamber 330, the second side of the disks 301 is exposed to a sputtering assembly 334 and the first side is exposed to a sustaining heater 332. The sputtering assembly 334 deposits a film on the second side of the disks 301 and the sustaining heater 332 sustains the temperature reached in the first chamber 310. Once the disks 301 have been sputtered, the disks 301 are transported out of the third chamber 330.

In FIG. 3, the chambers are illustrated with two heaters and sputtering assemblies on each side to process two disks at a time within each chamber. In alternative embodiments, the chambers may be configured to process one disk at a time or more than two disks at a time, with a corresponding number of heaters and sputtering assemblies on each side.

FIG. 4 is a cross-sectional top view of the second chamber 320, according to one embodiment of the present invention. It is to be appreciated that the third chamber 330 may be similarly arranged. The second chamber 320 includes a sputtering assembly 322 having a sputter target, for example, iron-platinum (FePt), disposed on one side of the chamber and a sustaining heater 324 disposed on an opposite of the chamber such that a carrier 410 securing a disk 301 via carrier springs 412 can be transported through the chamber 320 between the sputter assembly 322 and the sustaining heater 324.

In one embodiment, the sustaining heater 324 comprises a graphite heating element. Alternatively, other types of heating elements may be used in the sustaining heater 324, for example, a Pyrolytic Boron Nitride (PBN), an infra-red (IR) lamp, or other heating element. The heating power of the sustaining heater 324 is regulated by a controller to control the delivery of power to the sustaining heater 324 (or the heating element thereof). The components of a heater such as the controller are known in the art; accordingly, a detailed description is not provided. In one embodiment, the sustaining heater 324 is powered in a range of 0.1 kw to 12 kw. Alternatively, other power settings may be used and may also depend on the type of heater that is used.

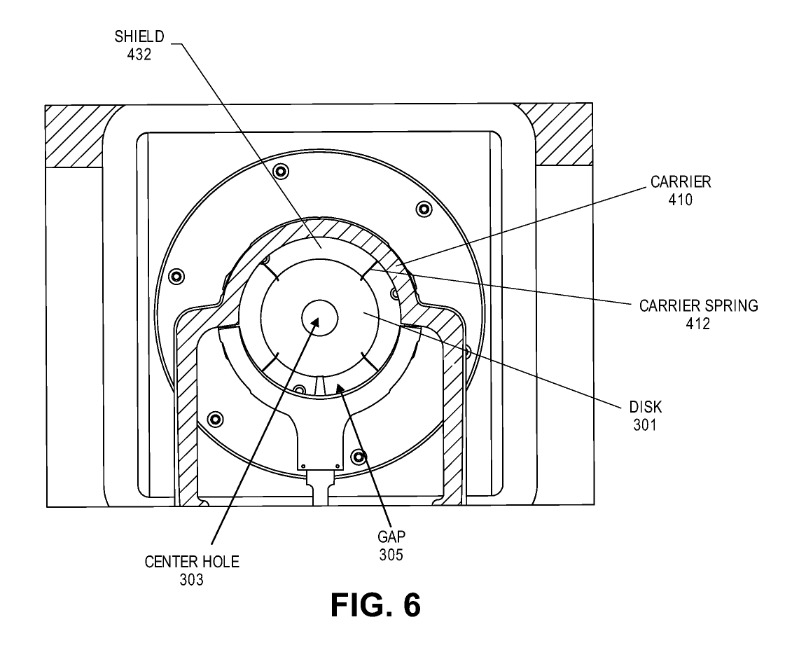

In the illustrated embodiment, the chamber 320 includes a shield 430. Because the disk may include a center hole and there may be a gap between the outer diameter (OD) of the disk and inner diameter (ID) of the carrier 410 (as illustrated below with respect to FIG. 6), sputtered material may be deposited on the heating element. This deposited material may damage the sustaining heater 324 and reduce the heating efficiency of the sustaining heater 324. In the illustrated embodiment, a shield 430 is mounted between the sustaining heater 324 and the carrier 410. This shield 430 can prevent a film of the sputtering material from depositing on the sustaining heater 324. And, at the same time, the shield 430 may also provide uniform heating to the disk 301, because it is thermally isolated to keep a high temperature and, thus, high heating rate.

The shield 432 may be composed of graphite, molybdenum, copper, or any other material. In one embodiment, the shield 430 is metal. In another embodiment, the shield 430 is not metal. In one embodiment, the shield 430 is between 0.5 millimeters (mm) and 3.5 mm thick. In one embodiment, the distance between the shield 430 and the carrier 410 is between 1.5 mm and 10 mm and the distance between shield 430 and the sustaining heater 324 is between 1 mm and 12 mm. To fully protect the sustaining heater 324, the shield 430 may have a surface area larger than that of the exposed portion of the sustaining heater 324. Similarly, the shield 430 may have a surface area larger than that of the disk 301. In other embodiments the surface area of the shield 430 is approximately equal to or less than that of the disk 301. For example, the shield may have a diameter between 80% and 120% of the outer diameter of the disk 301. Alternatively, the shield 430 may have other thicknesses, distances, surface areas, and diameters.

The shield 430 is removably or replacably disposed within a shield holder 432. Thus, once a certain amount of sputtering material has been deposited on the shield 430, it can be easily removed and replaced. Further, because of the materials used and simplicity of design, replacement of the shield 430 may be much less expensive than replacement of the sustaining heater 324 or the heating element thereof.

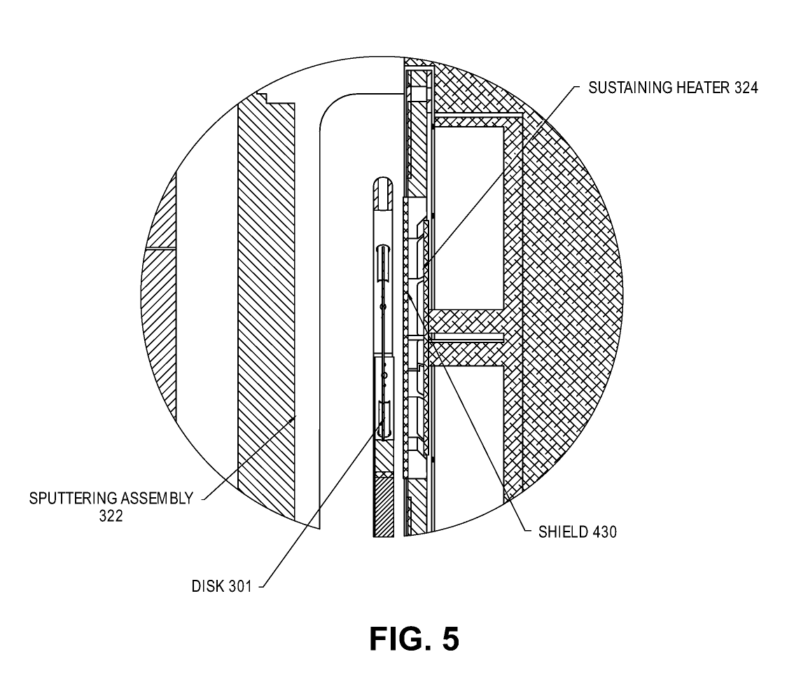

FIG. 5 is a cross-sectional top view of the second chamber 320, according to another embodiment. The disk 301 rests within a carrier and the sputtering assembly 322 deposits a thin film upon the disk 301. During the sputtering, a sustaining heater 324 on the opposite side of the disk 301 maintains the disk at a certain temperature. Further, a shield 320 protects the sustaining heater from the material put out by the sputtering assembly 322. In one embodiment, as illustrated in FIG. 5, the disk 301 is closer to the shield 430 and sustaining heater 324 than the sputtering assembly 322. In other embodiments, the disk is closer to the sputtering assembly 322 than the shield 430 and sustaining heater 324 or equidistant between the sputtering assembly 322 and shield 430 or equidistant between the sputtering assembly 322 and sustaining heater 324.

FIG. 6 is a cross-sectional side view of the second chamber 320, according to one embodiment of the present invention, shown from the perspective of the sputtering assembly 322. As discussed above, disks 301 are transported via a carrier 410 into and out of the second chamber 320. The disks 301 are supported in the carrier 310 by one or more carrier springs 412. Because the disks 301 have a center hole 303 and because there is a gap 305 between the outer diameter (OD) of the disk and inner diameter (ID) of the carrier 410, some of the sputtered material from the sputtering assembly may pass through (or around) the disk 301. Without a shield 430, the accumulation of sputter material on heater element may cause lower efficiency of the sustaining heater 324. In this embodiment, a shield 430 is placed between the carrier 410 and the sustaining heater 324 to try to block sputter material from depositing on the heater element of the heater 324.

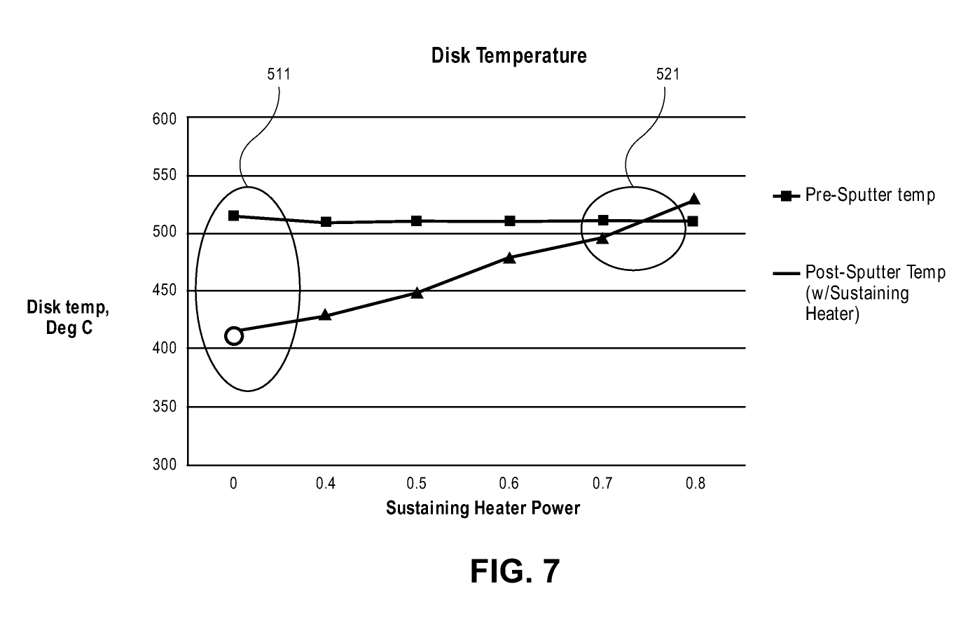

FIG. 7 is a graph of disk temperature versus sustaining heater power. The boxes indicate the pre-heat temperature of approximately 500 degrees in accordance with one embodiment. The triangles indicate the temperature after transport and sputter deposition. When the sustaining heater power is set to zero, or the sustaining heater is absent, as indicated by the oval 511, the disk temperature drops from over 500 degrees to just over 400 degrees during transport and sputter deposition. However, when the sustaining heater power is set appropriately, as indicated by the oval 521 and in this case approximately 0.7 kw, the disk temperature remains at approximately 500 degrees during transport and sputter deposition. Indeed, in one embodiment, the sustaining heater may even increase the temperature of the disk during transport and sputter deposition.

Sustaining the appropriate temperature during sputter deposition may have a number of advantages. For example, the media coercitivity may be improved up to 40%; the media jitter may be reduced by up to 2 nm; the media wsSNR may be improved by 3 or more dB; the media dcSNR may be improved by 3 or more dB; media D₁₀ may be improved by 150 or more kfci; and media sputter c-axis dispersion Δθ₅₀ may be decreased by 0.8-1.0 degrees.

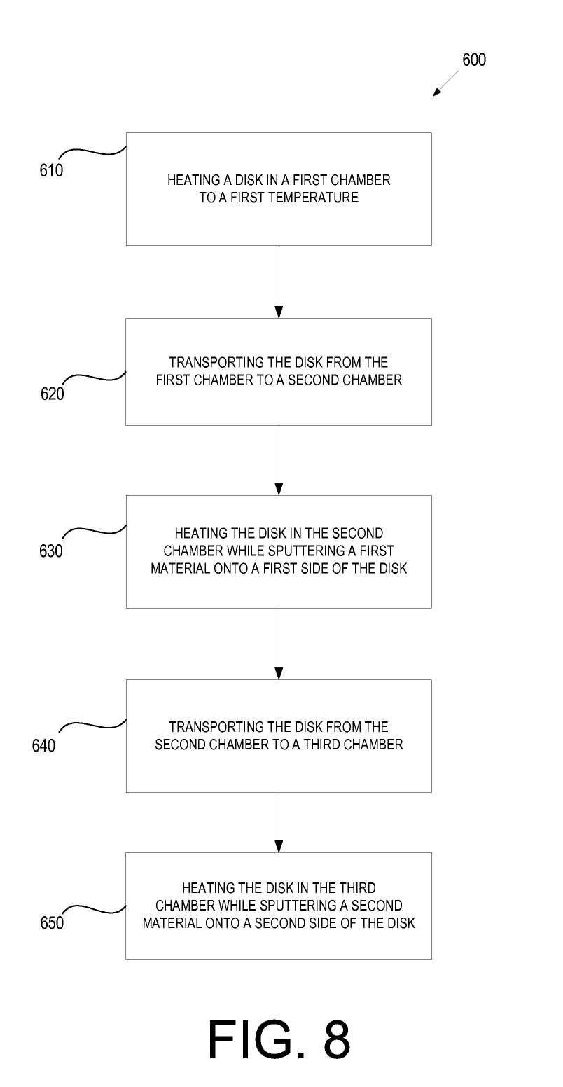

FIG. 8 is a flowchart of a method of processing a disk. The method 600 begins, in block 610, with heating a disk in a first chamber to a first temperature. The first temperature, for example, may be 500 degrees Centigrade. The first temperature may also be other temperatures higher or lower than 500 degrees Centigrade. The disk is heated from both sides by first and second heaters disposed on opposite sides of the first chamber. Thus, heating the disk includes heating both sides of the disk with the first and second heaters.

Next, in block 620, the disk is transported from the first chamber to a second chamber. While in the second chamber, in block 630, the disk is heated while a first material is sputtered onto only a first side of the disk. The first material may be, for example, FePt. The first material may be other materials. During the transporting of block 620 and the heating and sputtering of block 630, the disk is maintained within +/−5% of the first temperature in accordance with one embodiment of the present invention.

The disk may be heated by a heating element and the material may be sputtered by a sputtering assembly. In one embodiment, the method further includes shielding the heating element from the material sputtered by the sputtering assembly. For example, the shielding may be performed by using a graphite shield removably coupled to a shield holder.

Next, in block 640, the disk is transported from the second chamber to a third chamber. While in the third chamber, in block 650, the disk is heated while a second material is sputtered onto only a second side of the disk that is opposite the first side. The second material may be, for example, FePt. The second material may be other materials. During the transporting of block 640 and the heating and sputtering of block 650, the disk is maintained within +/−5% of the first temperature in accordance with one embodiment of the present invention.

While embodiments may be discussed above in regards to physical vapor deposition (PVD) sputtering of a FePt material for a recording layer of media, it should be noted that in alternative embodiments, other types of sputtering operations and sputtering materials may be used. It should be further noted that the apparatus and methods discussed herein may be used to generate other types of media layers and media types other than EAMR. In an alternative embodiment, for example, the apparatus and methods discussed herein may be used with non-EAMR media such as a PMR media.

The terms “above,” “under,” and “between” and “on” as used herein refer to a relative position of one media layer with respect to other layers. As such, for example, one layer disposed above or under another layer may be directly in contact with the other layer or may have one or more intervening layers. Moreover, one layer disposed between two layers may be directly in contact with the two layers or may have one or more intervening layers. In contrast, a first layer “on” a second layer is in direct contact with that second layer. Additionally, the relative position of one layer with respect to other layers is provided assuming operations are performed relative to a substrate without consideration of the absolute orientation of the substrate

In the foregoing specification, the present invention has been described with reference to specific exemplary embodiments thereof. It will, however, be evident that various modifications and changes may be made thereto without departing from the broader scope of the embodiments of the invention as set for in the appended claims. For example, although steps of embodiments of inventive methods may have been described in a specific order, one of skill in the art will understand that some of the steps described may occur simultaneously, in overlapping time frames, and/or in a different order from that described and claimed herein and fall within embodiments of the present invention. The specification and drawings are, accordingly, to be regarded in an illustrative rather than a restrictive sense.

What is claimed is:

1. A disk processing system, comprising:
a first chamber comprising first and second heaters disposed on opposite sides within the first chamber;
a second chamber coupled to first chamber, the second chamber comprising:
a first sputter assembly mounted within a first side of the second chamber to sputter a first side of a disk; and
a third heater mounted within a second side of the second chamber opposite the first side;
a third chamber coupled to the second chamber, the third chamber comprising:
a fourth heater mounted within a first side of the third chamber, the first side of the third chamber and the first side of the second chamber being the same; and
a second sputter assembly mounted within a second side of the third chamber opposite the first side.

2. The system of claim 1, wherein the second and third chambers each comprise:
a heater element of a respective heater within the chamber; and
a shield disposed between the heater element and a respective sputter assembly within the chamber.

3. The system of claim 2, wherein the shield is constructed from a material comprising graphite.

4. The system of claim 2, wherein the shield is removably coupled to a shield holder.

5. The system of claim 2, wherein the shield has a first surface area being larger than a second surface area of disk configured to be disposed between the shield and the sputter assembly using a carrier.

6. The system of claim 2, wherein the shield has a diameter in a range of 80% to 120% of an outer diameter of the disk.

7. The system of claim 2, wherein the shield holder is configured to secure the shield a distance from the heater element, wherein the distance is in a range of 1 millimeter (mm) to 12 mm.

8. The system of claim 2, wherein the shield holder is configured to secure the shield a distance from the disk when situated in the chamber using a carrier, wherein the distance is in a range of 1.5 millimeters (mm) to 10 mm.

9. The system of claim 2, wherein the shield has a thickness in a range of 0.5 millimeters (mm) to 3.5 mm.

10. The system of claim 3, wherein the heater element comprises graphite.

11. A disk processing method, comprising:
heating a disk in a first chamber to a first temperature, the first chamber comprising first and second heaters disposed on opposite sides within the first chamber;
transporting the disk from the first chamber into a second chamber;
heating the disk in the second chamber while sputtering a first material onto only a first side of the disk, wherein the disk is maintained within +/−5% of the first temperature during the transporting and sputtering during the transporting to and sputtering in the second chamber;
transporting the disk from the second chamber to a third chamber;
heating the disk in the third chamber while sputtering a second material onto only a second side of the disk opposite the first side, wherein the disk is maintained within +/−5% of the first temperature during the transporting to and sputtering in the third chamber.

12. The method of claim 11, wherein the first temperature is above 500 degrees Centigrade.

13. The method of claim 11, wherein the first and second materials comprises FePt.

14. The method of claim 11, wherein heating comprises using a heater disposed in the second chamber opposite to the first side of the disk.

15. The method of claim 14, wherein heating further comprises powering the heater in a range of 0.1 kw to 12 kw.

16. The method of claim 14, wherein the heater comprises a heating element and wherein the method further comprising shielding the heater element from the sputtering.

17. The method of claim 16, wherein shielding is performed using a shield being removably coupled to a shield holder, and wherein the shield holder is configured to secure the shield a distance from the disk in a range of 1.5 millimeters (mm) to 10 mm.

18. The method of claim 16, wherein the shield has a diameter in a range of 80% to 120% of an outer diameter of the disk.

19. A disk processing system, comprising:
means for heating a disk in a first chamber to a first temperature;
means for transporting the disk from the first chamber into a second chamber;
means for sputtering, in the second chamber, a first material onto only a first side of the disk while maintaining the disk within +/−5% of the first temperature during the transporting to and sputtering in the second chamber;
means for transporting the disk from the second chamber to a third chamber;
means for sputtering a second material onto only a second side of the disk opposite the first side while maintaining the disk within +/−5% of the first temperature during the transporting to and sputtering in the third chamber.

20. The disk processing system of claim 19, further comprising means for shielding a heater element in the second chamber from the sputtering.
